(19) United States
(12) Patent Application Publication
(10) Pub. No.: US 2014/0289693 A1
(43) Pub. Date: Sep. 25, 2014

(54) SYSTEM AND METHOD FOR IMPROVED NET ROUTING

(71) Applicants: Prasanth KODURI, San Jose, CA (US); Santhosh PILLAI, San Jose, CA (US)

(72) Inventors: Prasanth KODURI, San Jose, CA (US); Santhosh PILLAI, San Jose, CA (US)

(21) Appl. No.: 14/029,728

(22) Filed: Sep. 17, 2013

Related U.S. Application Data
(60) Provisional application No. 61/804,988, filed on Mar. 25, 2013.

(51) Int. Cl. G06F 17/50

(52) U.S. Cl. CPC G06F 17/5077
USPC 716/129

(57) ABSTRACT

An embodiment includes a method, comprising: receiving a layout of an integrated circuit having a shape with a perimeter; offsetting at least a part of a segment of the perimeter of the shape from the perimeter to generate an offset segment; forming a route segment in response to the offset segment; generating at least a part of a route with the route segment; and routing a net in the layout of the integrated circuit using the part of the route. Nets for integrated circuits may be routed using such techniques.

### CROSS REFERENCE TO RELATED PATENT APPLICATIONS

This patent application claims priority from U.S. Provisional Patent Application Ser. No. 61/804,988, filed on Mar. 25, 2013, the disclosure of which is hereby incorporated by reference for all purposes.

### BACKGROUND

Embodiments relate generally to the field of semiconductor integrated circuits (ICs). In particular this invention relates to the routing of power, ground, and signal nets in an integrated circuit.

The internal signals from ICs interface outside through Input/Output (IO) circuits (such as IO pads or IO Cells). The top 2 to 3 layers of copper metal layers may be used for power/ground distribution inside the chip. In a 9LM_{—}1RDL metal scheme, there are 9 copper metal layers for internal wiring and 1 Aluminum Layer for the Redistribution Layer or RDL. The topmost copper layer metal-9 (or M9) and metal-8 (or M8), which are the layers just below RDL, are used to make a power/ground mesh-like network. The RDL layer is used for connecting between flip-chip bumps and corresponding IO Cells for Power, Ground & Signals. Signal bumps are placed near to the chip edge for easier package routing and the core power/ground bumps are placed towards the core side of the chip. Under the signal bumps and VDD/VSS straps may be high speed digital circuits for which a good power delivery is required from the bump.

However, nets for power and ground for such circuits under the signal bumps may have increased resistance. Moreover, routing of the signal, power, and ground nets may not make use of optimal RDL routing resources and efficiently connect core VDD/VSS bumps to the straps in M9 & M8. The manual approaches may not achieve the most optimal power distribution and may be non-uniform and not repeatable.

### SUMMARY

An embodiment includes a method, comprising: receiving a layout of an integrated circuit having a shape with a perimeter; offsetting at least a part of a segment of the perimeter of the shape from the perimeter to generate an offset segment; forming a route segment in response to the offset segment; generating at least a part of a route with the route segment; and routing a net in the layout of the integrated circuit using the part of the route.

An embodiment includes a method, comprising: receiving a layout of an integrated circuit having a shape with a perimeter; expanding at least a part of a segment of the perimeter of the shape to generate an expanded segment; forming a route segment in response to the expanded segment; generating at least a part of a route with the route segment; and routing a net in the layout of the integrated circuit using the part of the route.

An embodiment includes a system, comprising: a memory configured to store a layout of an integrated circuit having a shape with a perimeter; and a processor coupled to the memory and configured to: offset at least a part of a segment of the perimeter of the shape from the perimeter to generate an offset segment; form a route segment in response to the offset segment; generate at least a part of a route with the route segment; and route a net in the layout of the integrated circuit using the part of the route.

An embodiment includes a computer-readable medium having instructions stored thereon, the instructions comprising instructions for: receiving a layout of an integrated circuit having a shape with a perimeter; offsetting at least a part of a segment of the perimeter of the shape from the perimeter to generate an offset segment; forming a route segment in response to the offset segment; generating at least a part of a route with the route segment; and routing a net in the layout of the integrated circuit using the part of the route.

An embodiment includes a method, comprising: offsetting at least a part of a perimeter of a shape from the perimeter to generate at least a part of a route; and routing a net using the part of the route.

An embodiment includes a method, comprising: expanding at least a part of a perimeter of a shape to generate at least a part of a route; and routing a net using the part of the route.

### BRIEF DESCRIPTION OF SEVERAL VIEWS OF THE DRAWINGS

FIG. 1A illustrates segments of a perimeter of a shape offset according to an embodiment.

FIG. 1B illustrates segments of a perimeter of a shape offset according to another embodiment.

FIG. 2 illustrates segments of FIG. 1A expanded according to an embodiment.

FIG. 3 illustrates examples of route segments generated using segments of FIG. 2 according to an embodiment.

FIG. 4A illustrates examples of route segments generated using vertices of segments of FIG. 2 according to an embodiment.

FIG. 4B illustrates examples of route segments generated using vertices of segments of FIG. 2 according to an embodiment.

FIGS. 5-10 illustrate examples of parts of routes generated using the route segments of FIGS. 3, 4A, and 4B according to various embodiments.

FIGS. 11-15 illustrate route segments generated from a variety of shapes according to various embodiments.

FIG. 16 is plan view of an integrated circuit layout with routes routed according to an embodiment.

FIG. 17 illustrates examples of route segments generated according to another embodiment.

FIGS. 18 and 19 illustrate examples of parts of routes generated using the route segments of FIG. 17 according to various embodiments.

FIG. 20 is a schematic view of an electronic system which may perform routing according to another embodiment.

### DETAILED DESCRIPTION

The embodiments relate to routing of integrated circuits. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations.

However, the methods and systems will operate effectively in other implementations. Phrases such as “exemplary embodiment”, “one embodiment” and “another embodiment” may refer to the same or different embodiments as well as to multiple embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

The embodiments are described in the context of particular routing systems having certain components and performing certain operations. One of ordinary skill in the art will readily recognize that the present invention is consistent with the use of routing systems having other and/or additional components and/or other features not inconsistent with the present invention. The method and system are also described in the context of single elements. However, one of ordinary skill in the art will readily recognize that the method and system are consistent with the use of having multiple elements.

It will be understood by those skilled in the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. Furthermore, in those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

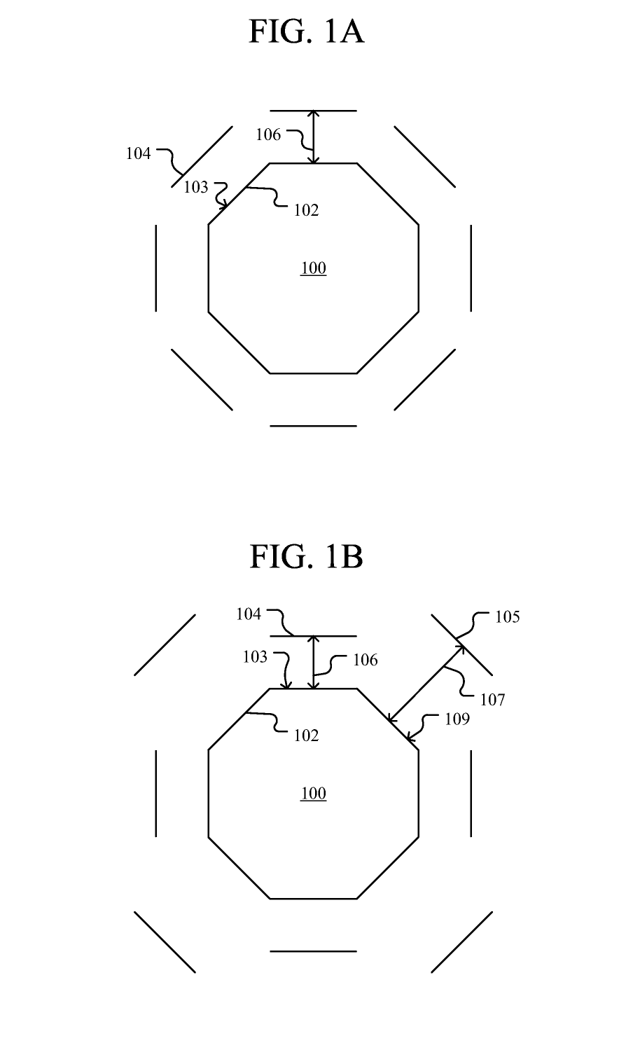

FIG. 1A illustrates segments of a perimeter of a shape offset according to an embodiment. An embodiment includes offsetting at least a part of a perimeter of a shape from the perimeter to generate at least a part of a route. In this embodiment, the shape 100 is an octagon. The perimeter is the perimeter 102 of the octagon.

The shape 100 includes multiple sides 102. In this case, the octagon includes eight sides. The sides 102 form at least part of the perimeter. Although all eight sides 102 are used as an example, as will be described in further detail below, less than all of the sides 102, portions of the sides 102, or the like may be used.

Each side 102 is offset to generate a corresponding segment 104. Here, the sides 102 are offset by a distance 106. Although the sides 102 are illustrated as being offset by the same amount 106, the sides 102 may be offset by different amounts.

In an embodiment, each of the segments 103 of the shape 100 may be offset in a direction substantially perpendicular to a corresponding edge of the shape 100. However, in other embodiments, the segments 103 may be offset in different directions.

FIG. 1B illustrates segments of a perimeter of a shape offset according to another embodiment. In this embodiment, the shape 100 has sides 102 and segments 103 as described above with respect to FIG. 1A. Segments 103 may similarly be offset by distance 106 to generate the corresponding segment 104. However, each of the segments of the shape 100 may, but need not be offset by the same amount.

For example, segment 109 of the shape 100 is offset by distance 107 to generate segment 105. As illustrated, some of the segments of the shape 100 are offset by distance 106 and others by distance 107. However, in other embodiments, each segment of the shape 100 may be offset by a different distance, one or more segments may be offset by the same distance while others are offset by different distances, or the like. Moreover, as will be described in further detail below, all of the segments of the shape 100 may, but need not be offset to generate new segments.

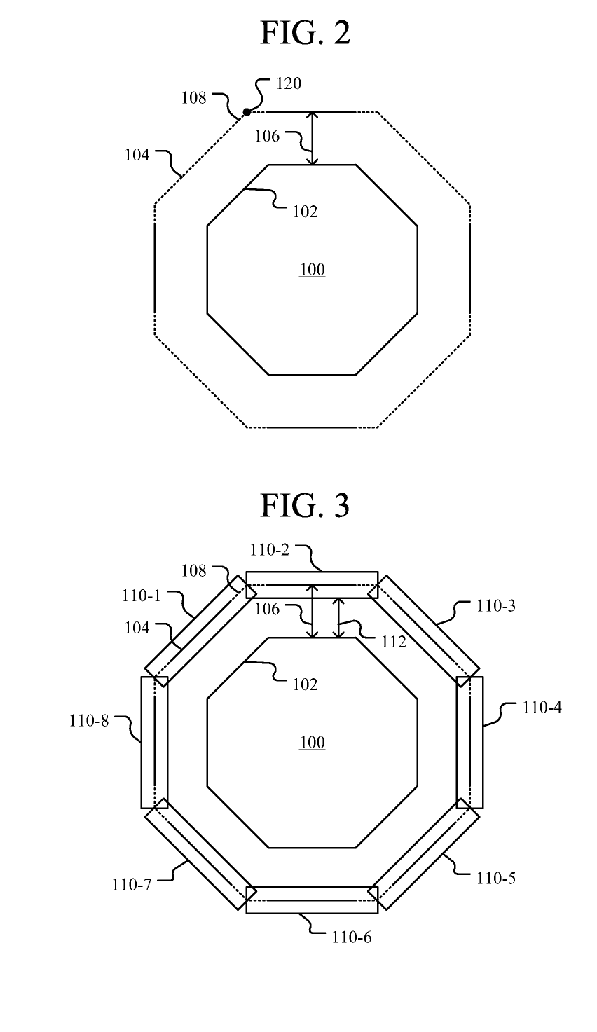

FIG. 2 illustrates segments of FIG. 1A expanded according to an embodiment. In an embodiment, once the segments 104 are created and are offset from the shape 100, the segments 104 may be lengthened. Here, the segments 104 are lengthened to create lengthened segments 108 illustrated with dashed lines.

In this embodiment, the lengthened segments 108 extend to vertices 120 where lines containing the segments 104 intersect. However, in other embodiments, the lengthened segments 108 may not extend to or may extend beyond such vertices 120.

An embodiment includes expanding at least a part of a perimeter 102 of a shape 100 to generate at least one segment 108. In this embodiment, the entire perimeter 102 or a part of the perimeter may be expanded to create the shape created by two or more of the lengthened segments 108. That is, although an embodiment has been described where the segments 103 are offset to create the segments 108, in this embodiment, the perimeter 102 is expanded to create the desired segments 108.

As will be described in further detail below, a net may be routed using one or more of the segments 108, parts of the segments 108, or the like. In some embodiments, the routing of the net may be performed automatically. That is, a user need not manually route nets around obstacles, bumps, or the like. Accordingly, routes of nets may be more uniform, may use space more efficiently, may be less dependent on the user or user preferences, or the like. Moreover, although an octagon has been used as an example of a shape 100, as will be described in further detail below, the shape 100 may take other forms.

Although the segments 104 of FIG. 1A have been used as examples of lengthened segments 108, other segments may similarly be lengthened. For example, a segment 105 of FIG. 1B may be lengthened to a vertex of a coincident expanded shape, lengthened to be aligned with but offset from a vertex 120, or the like.

FIG. 3 illustrates examples of route segments generated using segments of FIG. 2 according to an embodiment. In an embodiment, the segments 108 may be used to generate route segments 110. Here, each segment 108 has been used to generate corresponding route segments 110-1 through 110-8. In a commercial place and route tool, the route segments might not be in rectangular shape but might have octagonal shapes or other shapes at each end in order not to violate design rule checking (DRC) rules.

Although the route segments 110-1 through 110-8 have been illustrated as extending from end to end of the corresponding segments 108, the route segments 110-1 through 110-8 may extend up to and beyond the ends of the corresponding segments 108. For example, a route segment 110 may be lengthened or shorted to appropriately interface with another route segment to create a substantially uniform transition.

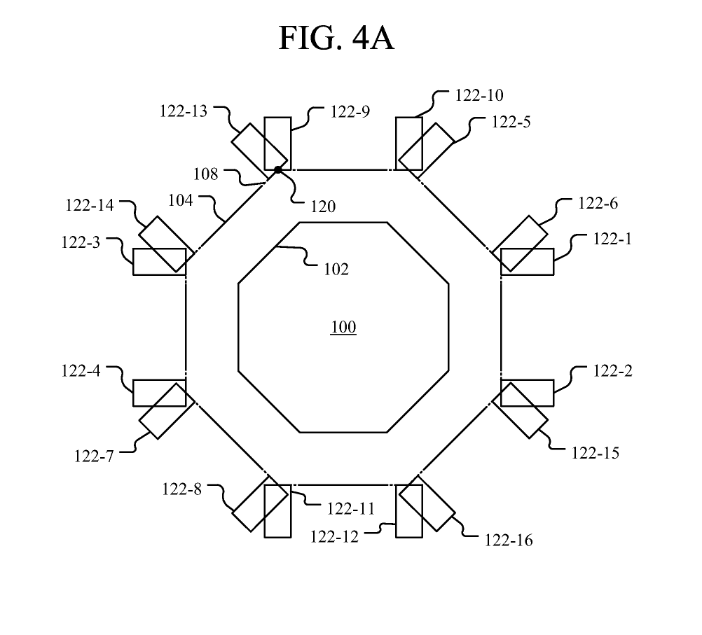

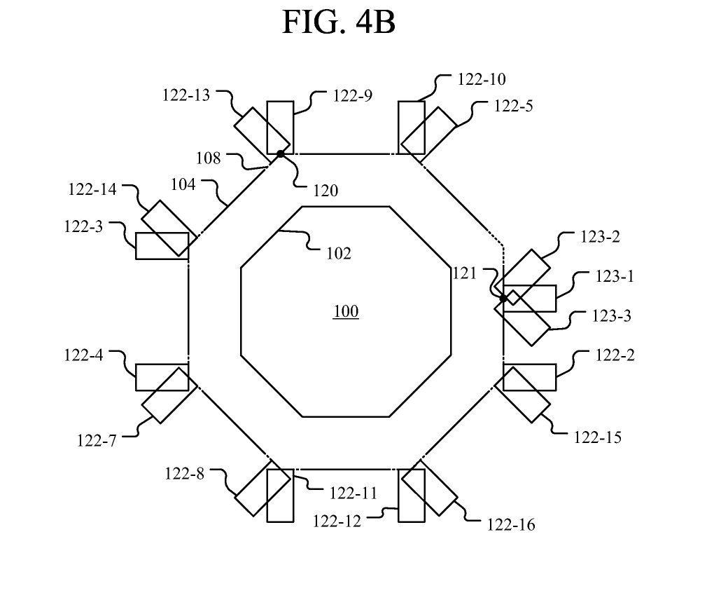

FIG. 4A illustrates examples of route segments generated using vertices of segments 108 of FIG. 2 according to an embodiment. In an embodiment, route segments 122 may be generated using the vertices 120. For example, a route segment 122 may be extended from a vertex 120. Multiple route segments 122 may be generated from the same vertex 120. Each of the route segments 122 from the same vertex 120 may extend in a different direction. For example, a first route segment 122-9 may extend in a direction substantially perpendicular from one segment 108 using the vertex 120. Another route segment 122-13 may extend in a direction substantially perpendicular to the other segment 108 using the vertex 120. Route segments 122-1 through 122-16 represent examples of route segments generated using the vertices 120.

Although the route segments 122 have been described as being substantially perpendicular to a segment 108, in other embodiments, the route segments 120 may extend in other directions. For example, the route segment 122 may extend in a direction substantially independent of the shape. In another example, a route segment 122 may extend in a direction that bisects the angle at the vertex 120. In yet another example, a route segment 122 may extend in any direction within the obtuse angle formed by two segments 108.

FIG. 4B illustrates examples of route segments generated using vertices of segments of FIG. 2 according to another embodiment. In this embodiment, route segments 122 may extend from vertices 120 similar to FIG. 4A. However, in this embodiment, route segments 123 may extend from a vertex 121 that is not a vertex of an expanded shape. Here, vertex 121 is on a segment 108, but not an endpoint of the segment 108.

Route segments 123 may extend in a variety of directions from vertex 121. For example, route segment 123-1 extends from the vertex 121 substantially perpendicularly from the corresponding segment 108. Route segments 123-2 and 123-3 extend in directions that are substantially perpendicular to adjacent segments 108.

Although route segments 123 have been described as extending substantially perpendicular to a corresponding segment 108, the route segments 123 may extend in any angle similar to route segments 122 described above. Moreover, although one vertex 121 and corresponding route segments 123 have been used as an example, any number of vertices 121, whether on the same segment 108 or on different segments like 108, may be used to generate corresponding route segments 123.

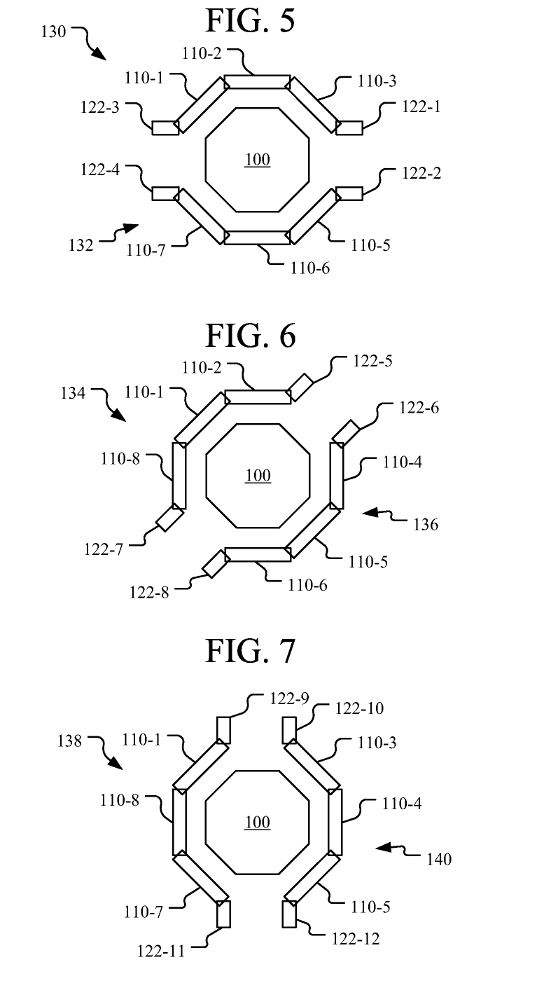

FIGS. 5-10 illustrate examples of parts of routes generated using the route segments of FIGS. 3, 4A, and 4B according to various embodiments. In an embodiment, the various route segments described above may be combined in various ways to form at least part of a route.

Referring to FIG. 5, route segments 110 and 122 are combined to create two route segments 130 and 132. From FIG. 3, route segments 110-1, 110-2, and 110-3 are used to form parts of route segment 130 while route segments 110-5, 110-6, and 110-7 are used to form parts of route segment 132. From FIG. 4, route segments 122-1 and 122-3 are used to form parts of route segment 130 while route segments 122-2, and 122-4 are used to form parts of route segment 132. Both route segments 130 and 132 avoid shape 100. In particular, as components of the route segments 130 and 132 have been formed from segments offset from the shape 100, the route segments 130 and 132 may avoid the shape 100. In an embodiment, route segments 130 and 132 may be parts of different nets, however, in other embodiments, the route segments 130 and 132 may be part of the same net.

Route segments 134 and 136 of FIG. 6 are similar to route segments 130 and 132 of FIG. 5. However, the route segments 134 and 136 have been formed from different route segments of FIGS. 3 and 4. From FIG. 3, route segments 110-1, 110-2, and 110-8 are used to form parts of route segment 134 while route segments 110-4, 110-5, and 110-6 are used to form parts of route segment 136. From FIG. 4, route segments 122-5 and 122-7 are used to form parts of route segment 134 while route segments 122-6, and 122-8 are used to form parts of route segment 136.

Similarly, route segments 138 and 140 of FIG. 7 are similar to route segments 130 and 132 of FIG. 5 and are also formed from different route segments of FIGS. 3 and 4. From FIG. 3, route segments 110-1, 110-7, and 110-8 are used to form parts of route segment 138 while route segments 110-3, 110-4, and 110-5 are used to form parts of route segment 140. From FIG. 4, route segments 122-9 and 122-11 are used to form parts of route segment 138 while route segments 122-10, and 122-12 are used to form parts of route segment 140.

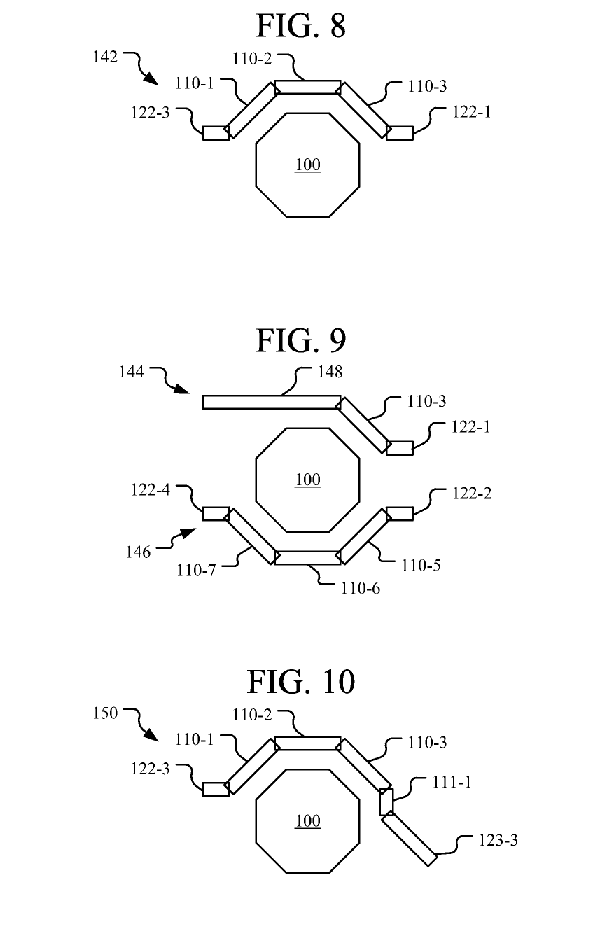

Route segment 142 of FIG. 8 is similar to route segment 130 of FIG. 5. However, in this embodiment, other route segments are not formed. That is, a route segment similar to route segment 132 need not be formed.

Route segments 144 and 146 of FIG. 9 are similar to route segments 130 and 132 of FIG. 5. However, route segment 144 does not include route segments 110-1 and 122-3 at the ends. In contrast, route segment 144 includes a route segment 148 that is similar to route segment 110-2 extended further than in FIGS. 5, 6, and 8. In other words, other route segments that are not related to the shape 100, related in different ways, or the like may be combined with the route segments of FIGS. 3 and 4 to create new route segments.

Route segment 150 of FIG. 10 is similar to route segment 142 of FIG. 8. However, in this embodiment, route segment 150 does not include route segment 122-1. Instead, route segment 150 includes route segments 111-1 and 123-3. Route segment 111-1 is an example of a route segment generated using vertices 120 and 121 of FIG. 4B described above. That is, route segment 111-1 extends from the vertex 120 of an expanded shape to the vertex 121 on a segment 108. Route segment 123-3 extends from the vertex 121. Although using route segments associated with a vertex similar to vertex 121 have been used as an example, in other embodiments, route segments generated from other vertices along the various segments 108 or other segments may be used.

Although the discontinuities are illustrated in the route segments described above, structures may be formed between the route segments, as part of the individual route segments, or the like. Accordingly, the route segments may be formed without such discontinuities.

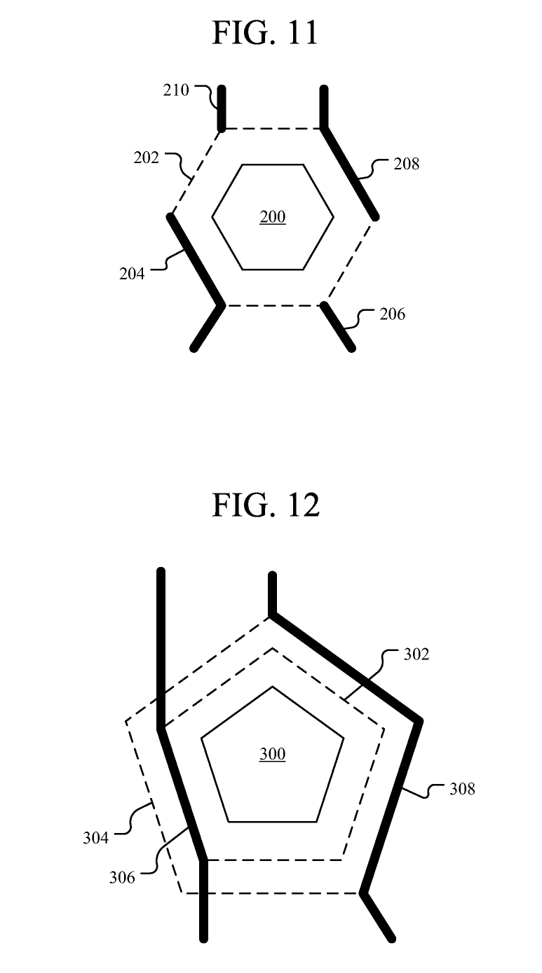

FIGS. 11-15 illustrate route segments generated from a variety of shapes according to various embodiments. Referring to FIG. 11, the shape is a hexagon. The dashed line 202 illustrates an example of segments offset and extended from the shape 200. Multiple route segments 204, 206, 208, and 210 are illustrated using segments of the expanded shape 202.

Referring to FIG. 12, the shape 300 is a pentagon. In this embodiment, segments of the shape 300 have been expanded into segments aligned with two different shapes 302 and 304. Route segment 306 is formed from a segment of shape 302 and segments formed using vertices of shape 302. Route segment 308 is formed using segments and vertices of shape 304. In other words, segments that have been offset from an original shape 300 by different distances may be used to create routes around the same shape 300.

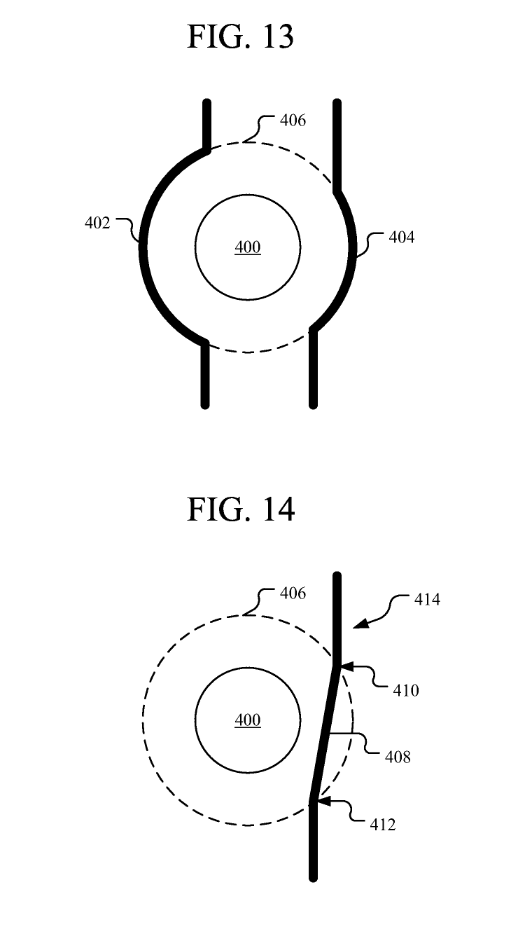

Referring to FIG. 13, the shape 400 is a circle. That is, in an embodiment, the shapes need not be polygons with a limited number of sides and may also contain continuous curves. As the shape 400 does not have vertices, the vertices of segments use to create route segments 402 and 404 may be created as desired from the shape 406. For example, an arc of the circle 400 may be offset and expanded into the arc of the route segment 402 or the arc of the route segment 404. Accordingly, the route segments 402 and 404 may include arcs following at least a part of the expanded circle 406.

Referring to FIG. 14, the shape 400 is a circle similar to FIG. 13. Although arcs of route segments 402 and 404 have been described above, other route segments using vertices along shape 406 may be generated. In this embodiment, a route segment 414 includes a chord as route segment 408. The chord of route segment 408 extends between vertices 410 and 412 along shape 406. This can be extended to a polygon provided the minimum distance from the bump to the route segment 408 is met.

Although a chord and an arc associated with the shape 406 have been used as examples, the route segments between the corresponding vertices may take other forms. For example, the route segment may form an arc that extends between vertices 410 and 412 but is not otherwise coincident with the shape 406. In another example, a route segment may take a path between vertices 410 and 412 that is arbitrary, not based on other route segments or shapes, or the like.

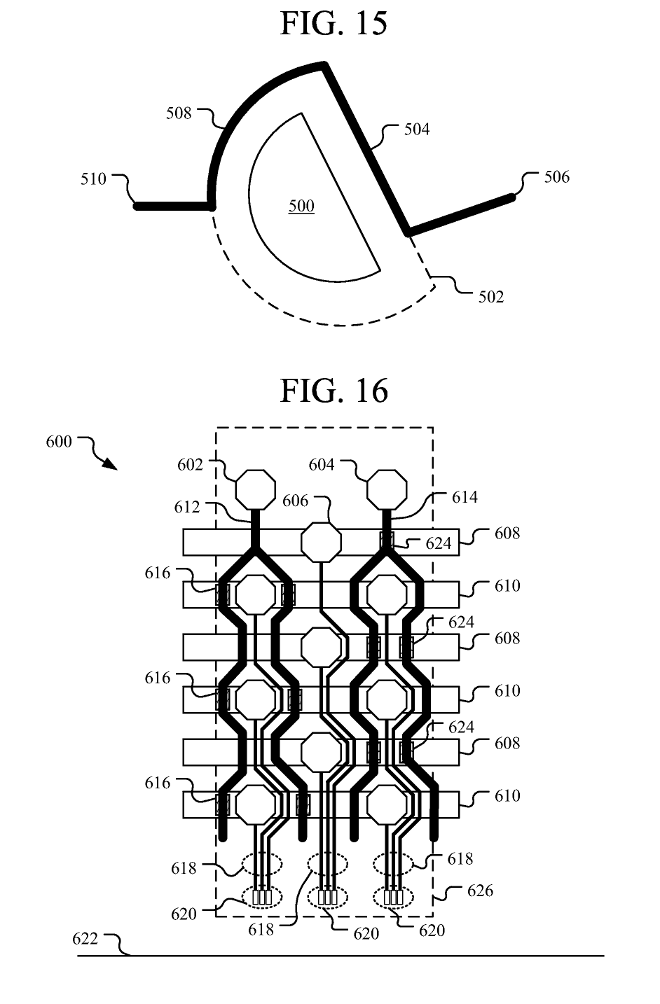

Referring to FIG. 15, the shape 500 is an irregular shape. That is, the shape 500 includes an arc and a straight segment. Although a particular irregular shape has been used as an example with an arc and a segment, any number of arcs, segments, curves, or the like may be used to form the shape.

Using the shape 500 as an example, an arc segment 508 may be formed along the expanded shape 502. A segment 510 may extend from the desired point forming the end of the arc segment 508. A straight segment 504 may also be formed along the expanded shape 502. Similar to the arc segment 508, an end of the straight segment 504 may not extend to the end of the corresponding segment of the expanded shape 502. A segment 506 may extend from the desired end of the straight segment 504.

In other words at least a part of the perimeter of the shape 500 used to generate a route segment may but need not contain all of a corresponding segment of the shape 500. That is, the part may be less than all of the corresponding segment of the shape 500.

Although a segment, an arc, a curve, or the like have been used to distinguish features of a shape, such entities may be offset, expanded, lengthened, shortened, or the like as described above with respect to segments.

FIG. 16 is plan view of an integrated circuit layout with routes routed according to an embodiment. In this embodiment, the layout 600 represents interconnections layers used to interface to circuitry 626 internal to the integrated circuit. The circuitry 626 may be digital circuitry. Here, the layout 600 includes bumps 602, 604, and 606. The circuitry 626 may be disposed under bumps 602, 604, and 606. In other embodiments, the circuitry 626 may be disposed only under the bumps 606.

In this embodiment, bumps 602 and 604 are used for power connections. Bump 606 is used for signal connections, such as for inputs and outputs. For clarity, octagonal shapes similar to bump 606 but not labeled with a reference number may also be used for signal connections.

Using Vₛₛ and V_{dd} as examples, bump 602 and bump 604 may be used to connect Vₛₛ and V_{dd}, respectively. Straps 608 and 610 are disposed on a layer to route power to circuitry 626 on a periphery of the integrated circuit. Bumps 606 may be disposed at or near an edge 622 of the integrated circuit. The straps 608 and 610 may supply power to circuitry 626 near the edge 622. However, since the bumps 606 may occupy substantially all of the bump locations near the edge 622, power connections through bumps 602 and 604 may be offset from the circuitry 626 needing the power. Nets 612 and 614 couple Vₛₛ and V_{dd} to the straps 610 and 608 through vias 616 and 624, respectively. These nets 612 and 614 may be routed around not only the bumps 606, but also nets 618 coupling the bumps 606 to pins 618 of the integrated circuit.

Forming the nets 612, 614, and 618 may be performed using the techniques described above on a received layout. For example, a straight route may be used to couple a bump 606 closest to the edge 622 to the corresponding pin 620. However, for a bump 606 further away from the edge 622, the shape of the bump 606 may be used to generate route segments as described above. In another example, for a bump 606 even further offset from the edge 622, other bumps 606 and corresponding route segments 618 may also be used as shapes to generate route segments as described above.

For example, design rules may specify a width W of a route for nets 618. Similarly, design rules may specify a minimum separation D between a route and an adjacent conductive structure. Referring to FIGS. 1-3 and 16, for example, the distance 106 may be equivalent to D+W/2. That, is the segment 104 is offset by D+W/2. A route segment 110 may be created with a width W centered on a corresponding segment 108. As a result, a route meeting the design rules may be formed.

In an embodiment, once the nets 618 have been formed, nets 612 and 614 may be formed. The bumps 606 and nets 618 may be used as shapes to generate route segments of the nets 612 and 614. That is, the shapes of the bumps 606 and nets 618 may be used to generate segments from which route segments may be formed. Using the route segments the nets 616 and 614 may be routed to the corresponding vias 616 and 624 substantially adjacent the bumps 606.

In an embodiment, the nets 612, 614, and 618 may be routed on a redistribution layer of the integrated circuit. However, in other embodiment, the nets may be routed on different layers. Moreover, although routing at an input/output interface to an integrated circuit has been used as an example, the routing techniques described here, may be applied to routing other portions of integrated circuits or other similar structures.

In an embodiment, an integrated circuit Flip-Chip implementation consists of IO pads and bumps and RDL (Redistribution Layer) metal layer which interface with the outside world. The RDL layer connects the pads and the bumps. The bumps may be divided into core power and ground bumps and IO (Input/Output) bumps. The core power and ground bumps may be disposed in the center of the chip and the IO bumps may be disposed around the periphery of the chip. The circuitry 626 located below the bumps may receive less power due to an IR drop. To reduce the IR drop and to effectively utilize the RDL layer, automatic sneaking from the nearest power and ground bumps into the IO bumps may be performed.

In an embodiment, the use of RDL layer for signal, power and ground signals may be improved and optimized. In addition the overall IR drop of the IC chip may be reduced. Such routing may be performed automatically.

As described above, such routing may be performed by expanding polygons/circles and using the new coordinates to generate shapes. New metal shapes like pipes may be formed starting at one coordinate and extend in another direction or to another coordinate. The pipes may be similar to the route segments described above. For example, the pipes may be similar to the route segments 122, 123, or the like as described above with respect to FIGS. 4A and 4B.

In an embodiment, the core power and ground bumps are mainly concentrated in the center of the chip. There could be place and route partitions (hierarchical designs) that are physically located under the IO bump region. These place and route partitions may not receive enough power supply due to lack of enough power and ground bumps in the IO bump region. In order to supply power, the power and ground nets are routed from the nearest power and ground bumps similar to those in FIG. 16. These power and ground RDL routes connect to the lower level power mesh of straps 608 and 610 using vias 616 and 624 as shown in FIG. 16.

In an embodiment, to improve routing efficiency, to avoid any opens of IO RDL nets and also allow enough sneaking of core power/ground nets from the core region into the IO region, snake routing may be used. Snake Routing may refer to routing a net on the RDL in a zigzag pattern resembling the shape of a moving snake. The IO nets may be routed around the periphery of the staggered bumps taking shape of the bumps (instead of following a straight path). This may create a snake like routing pattern.

In an embodiment, this kind of snake routing may be done for a variety of types of nets, such as IO nets and core power/ground nets. For nets related to the IOs: the nets may be generally routed in the area above the IO pads and connect the IOs to the nearest bump. These nets may be generally routed first to get the shortest and cleanest routing. For core power/ground nets, the nets may be VDD/VSS nets that are routed from the core area into the area of the IO pads. These nets may be routed last and are generally “sneaked” into the IO area as much as possible. The necessity of this routing is only to decrease IR drop near the IO region. Although sneaking and snaking routes have been separately described herein, routing techniques described above may be used both for sneaking and snaking routes.

To achieve snake routing, consider the bump shape. As described above, bumps may include contain a series of regular octagon's placed in staggered or linear fashion. A regular octagon has 8 edges of length 5 and 8 vertices. For a given X₀ and Y₀ coordinate, the coordinates of the octagon can be obtained as described in Table 1.

TABLE 1

| Coordinate | X | Y |
|---|---|---|
| 1 | X₀ + 0.707 S | Y₀ |
| 2 | X₀ + 1.707 S | Y₀ |
| 3 | X₀ + 2.414 S | Y₀ + 0.707 S |
| 4 | X₀ + 2.414 S | Y₀ + 1.707 S |
| 5 | X₀ + 1.707 S | Y₀ + 2.414 S |
| 6 | X₀ + 0.707 S | Y₀ + 2.414 S |
| 7 | X₀ | Y₀ + 1.707 S |
| 8 | X₀ | Y₀ + 0.707 S |

In Table 1, 0.707 have been used to represent 1/√2. However, in another embodiment, a more accurate value may be used.

Once the coordinates are calculated, the octagon may be represented in physical space as a list of vertices with equivalent X and Y coordinates as shown in Table 1. A function called “create_octagon” may be used to create an octagon for a given origin (X,Y) and length “s”, using the formulas above.

A function “create_octagon_edges” may be used to create octagon edges from a given list of octagon coordinates. For example, each adjacent pair of coordinates described above may be used to create a segment of the octagon.

In order to create metal shapes or other route segments, a pair of X,Y coordinates may be generated. To create the sneak patterns similar to nets 618, coordinates around the octagon offset at a given distance(d) may be created. Then the metal shapes of a given width(w), for each of the edges offset edges may be created.

In an embodiment, the coordinates around the octagon at a distance of d+w/2 may be identified. For example, the coordinates of the segments 104 of FIG. 1 may be identified. Then, those coordinates may be used to create the metal shapes. To achieve this, the coordinates of the octagon may be expanded or resized to obtain the new coordinates. First the individual edges of the octagon may be expanded to find the substantially parallel edge at a distance of d+w/2. The new coordinates of the parallel edges can be obtained by either adding or subtracting a value from the X and Y coordinates of the corresponding edge. The new coordinates for the horizontal and vertical edges can be derived by either adding or subtracting d+w/2, whereas as the 45° edges are derived by adding and/or subtracting ((d+w/2)*sin 45) or ((d+w/2)*cos 45) depending on the right angle triangle at that edge. Although here sin 45 is equal to cos 45, in other embodiments with shapes of different angles, the values may not be the same. Accordingly, the length of the appropriate side of the right triangle may be added or subtracted as appropriate.

Next the intersection of these edges maybe used to find the new expanded coordinates. The intersection of these edges can be found by using another right angle triangle. The opposite and adjacent sides of these triangles are the difference in the X and Y coordinates between two adjacent edges. This difference is used to calculate the new X and Y coordinates where two adjacent expanded edges intersect.

Although a particular technique for finding the coordinates has been described above, other techniques may be used. For example, a vertex of the original octagon may be expanded and the expanded vertices may be used for the vertices of the expanded polygon.

Once an expanded polygon is generated, metal shapes around the bumps may be created. However there are other shapes we might want to create metal shapes called pipes. The pipes are the metal pieces that originate from the vertices of individual edges of the octagon and extend up to a length called pipe_length. These pipes provide room to access the bumps. The pipes may be similar to the route segments 122 described above.

To create the metal shapes around an octagonal bump, a function called “create_metal_shapes_around_bump” may takes the following inputs: Edges—the list of edges metal shapes need to be created connecting the coordinates of the edge, the valid values may be 0-7, for each of the edges. Pipe_edges—the list of edges pipe metal shapes need to be created, the valid values may be 0-7, for each of the edges. Pipe_length—length of the pipe metal shape. The value may be a float or integer. Distance—distance of the metal from the octagonal bump boundary. The value may be a float or integer. Width—width of the metal. The value may be a float or integer. Net_name—the name of the net for which the metal shape need to be created, such as VDD, VSS, or the like. Octagon—the coordinates of the octagon.

The result of the function may be the creation of regular metal shapes around the bump based on the choice of the inputs provided. All the permutations and combinations of the edges and pipe_edges can be used to generate the shapes. FIGS. 5-10 described above show examples of outputs of the function.

Although particular parameter types, such as floats and integers have been described above, other types may be used for the desired precision, the capabilities of the layout system, or the like.

In an embodiment, the code for such functions may be written in a variety of languages. For example, the code may be written in TCL (Tool command Language) and a tool used may be a commercial place and route tool.

Accordingly, in an embodiment, core power and ground sneaking may be created using snake like patterns. These routes may act like a guide for RDL router to route the nets in snake like pattern as shown in FIG. 16. Snake routing pattern has been achieved nets similar to those in FIG. 16. There may be more regular sneaking of the core VDD/VSS nets and one of the previously open 10 net is now routed clean.

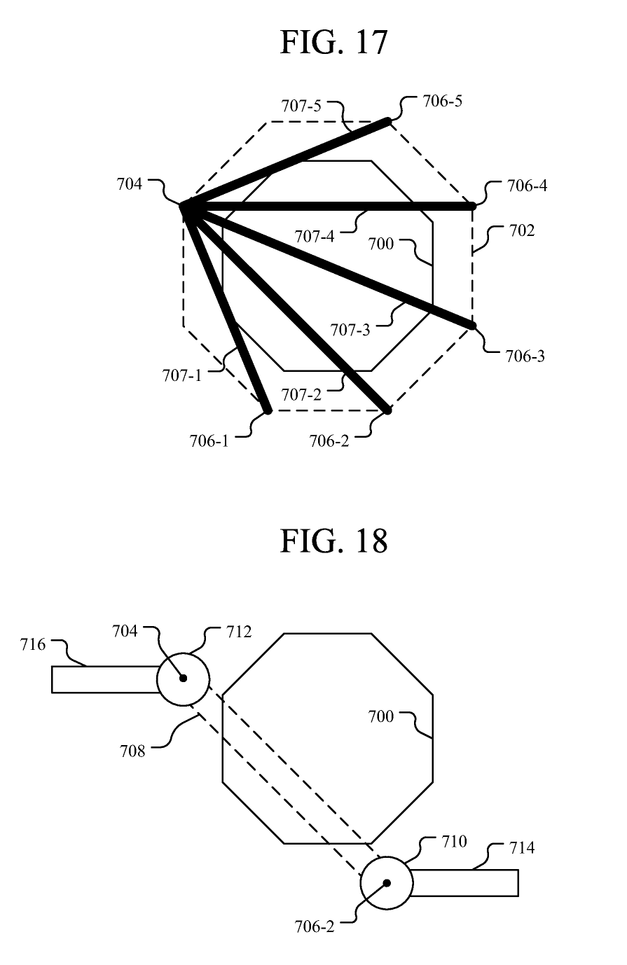

FIG. 17 illustrates examples of route segments generated according to another embodiment. In this embodiment, a shape 700 may be used to generate an expanded shape 702 and/or vertices 704 and 706. The shape 700 here is similar to the shape 100 described above; however, other shapes may be used. Route segments 707 are formed between vertex 704 and a corresponding one of the vertices 706. For example, route segment 707-1 is formed between vertex 704 and vertex 706-1, route segment 707-2 is formed between vertex 704 and vertex 706-2, and so on.

In contrast to the route segments described above, the route segments 707 need not follow the expanded shape 702. That is, the vertices used to create the route segments 707 are not adjacent vertices along the expanded shape 702. This does not mean that the route segments 707 cannot be used with route segments formed with adjacent vertices, but rather that the route segments 707 are alternative and/or supplementary route segments.

Although route segments 707 have been illustrated as having one vertex, 704 in common, other route segments may have other vertices in common. That is, using vertex 704 is merely and an example, and other route segments may be generated using other vertices that extend to other non-adjacent vertices.

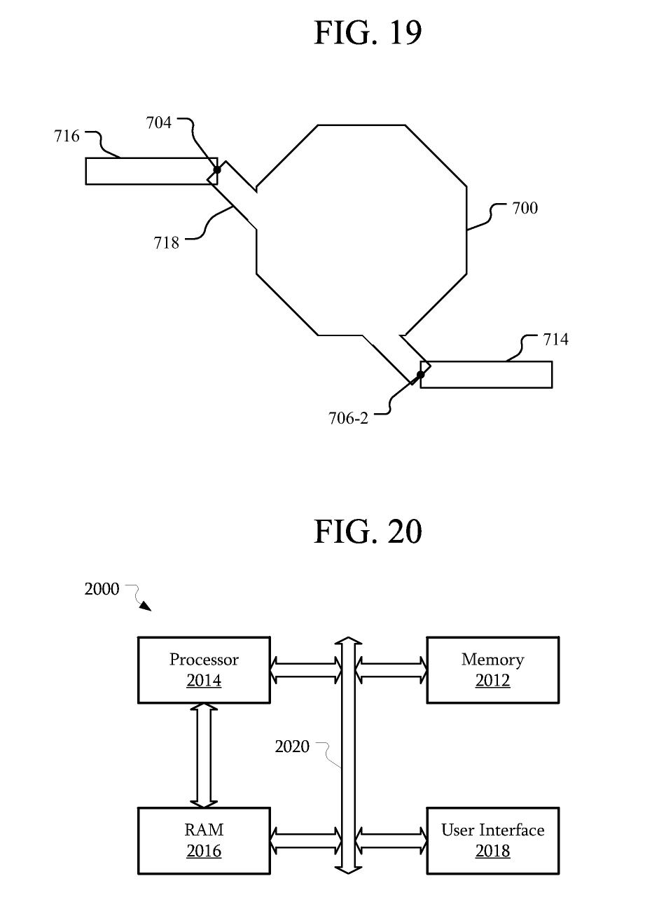

FIGS. 18 and 19 illustrate examples of parts of routes generated using the route segments of FIG. 17 according to various embodiments. Referring to FIGS. 17 and 18, a route segment 708 is generated similar to route segment 707-2. The route segment 707-2 extends from vertex 704 to vertex 706-2.

In this embodiment, the route segment 708 overlaps with the shape 700. However, the route segment 708 is routed on a different layer from the shape 700. For example, route segment 708 may be routed on a different RDL layer in a layout with a multi-layer RDL. Here, vias 710 and 712 couple the route segment 708 to route segments 714 and 716.

Although two vias 710 and 712 are illustrated, in other embodiments, other route segments may be disposed on the same layer as route segment 708. For example, route segment 716 may be disposed on the same layer as route segment 708. The route segments 708 and 716 may be coupled without the via 712.

Referring to FIGS. 17 and 19, a route segment 718 again extends from vertex 704 to vertex 706-2 and is coupled to route segments 714 and 716. However, the route segment 718 may be generated on the same layer as the shape 700. As a result, the route segment 718 is shorted to the shape 700. In an embodiment, the shape 700 and the route segment 718 may be part of the same net, such as a VSS net. Accordingly, a route segment 718 that intersects the shape 700 may be selected.

Although the route segments 714, 716, and 718 are illustrated as having rectangular ends, the ends may be selected as desired. Moreover, although various dimensions, positions, or the like of route segments and shapes have been described above, the dimensions, positions, or the like may be selected to comply with constraints of design rules.

FIG. 20 is a schematic view of an electronic system which may perform routing according to an embodiment. The electronic system 2000 may be part of a wide variety of electronic devices such as a computer including, but not limited to, a portable notebook computer, Ultra-Mobile PCs (UMPC), Tablet PCs, a server, workstation, a mobile telecommunication device, and so on. For example, the electronic system 2000 may include a memory system 2012, a processor 2014, RAM 2016, and a user interface 2018, which may execute data communication using a bus 2020. The user interface 2018 may allow a designer to route a layout using the techniques described above.

The processor 2014 may be a microprocessor or a mobile processor (AP). The processor 2014 may have a processor core (not illustrated) that can include a floating point unit (FPU), an arithmetic logic unit (ALU), a graphics processing unit (GPU), and a digital signal processing core (DSP Core), or any combinations thereof. The processor 2014 may execute the program and control the electronic system 2000.

The RAM 2016 may be used as an operation memory of the processor 2014. Alternatively, the processor 2014 and the RAM 2016 may be packaged in a single package body.

The user interface 2018 may be used in inputting/outputting data to/from the electronic system 2000. For example, the user interface 2018 may include a display for viewing the layout, input/output devices to manipulate routes, initiate automatic routing or the like as described above.

The memory system 2012 may store codes for operating the processor 2014, data processed by the processor 2014, or externally input data, such as a layout of an integrated circuit. The memory system 2012 may include a controller and a memory. The memory system may include an interface to computer readable media, such as hard drives, solid state drives, optical drives, flash memory, network attached storage, or the like. Such computer readable media may store instructions to perform the variety of operations describe above.

Reference throughout this specification to “one embodiment” or “an embodiment” means that a particular feature, structure, or characteristic described in connection with the embodiment is included in at least one embodiment of the present invention.

Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Although the structures, methods, and systems have been described in accordance with exemplary embodiments, one of ordinary skill in the art will readily recognize that many variations to the disclosed embodiments are possible, and any variations should therefore be considered to be within the spirit and scope of the apparatus, method, and system disclosed herein. Accordingly, many modifications may be made by one of ordinary skill in the art without departing from the spirit and scope of the appended claims.

1. A method, comprising:
receiving a layout of an integrated circuit having a shape with a perimeter;
offsetting at least a part of a segment of the perimeter of the shape from the perimeter to generate an offset segment;
forming a route segment in response to the offset segment;
generating at least a part of a route with the route segment; and
routing a net in the layout of the integrated circuit using the part of the route.

2. The method of claim 1, wherein the at least the part of the segment of the perimeter includes less than all of the segment of the perimeter.

3. The method of claim 1, wherein the at least the part of the perimeter is an arc.

4. The method of claim 1, further comprising:
generating a vertex using the at least the part of the perimeter; and
extending a segment from the vertex;
wherein routing the net comprises routing the net using the extended segment.

5. The method of claim 4, wherein the extended segment extends substantially perpendicular to the perimeter.

6. The method of claim 1, wherein:
offsetting the at least the part of the segment of the perimeter of the shape comprises:
selecting a plurality of segments of the shape; and
offsetting each of the selected segments of the shape in a direction substantially perpendicular to a corresponding edge of the shape; and
further comprising lengthening each of the offset segments of the shape to intersect with at least one other offset segment.

7. The method of claim 1, wherein the shape is an octagon.

8. The method of claim 1, wherein the shape is a bump.

9. The method of claim 1, wherein the shape is a second net.

10. The method of claim 1, the net referred to as a first net, the method further comprising:
routing a second net from a bump to a pin;
wherein the shape includes at least one of the bump and the second net.

11. The method of claim 10, further comprising routing the first net to a via adjacent the bump.

12. The method of claim 1, further comprising:
expanding a perimeter of a second shape to generate at least one segment of a third shape; and
routing the net using the at least one segment of the third shape.

13. The method of claim 1, further comprising routing the net on a redistribution layer of a semiconductor device.

14. The method of claim 1, wherein forming the route segment in response to the offset segment further comprises forming the route segment using vertices based on non-adjacent vertices of the shape.

15. A method, comprising:
receiving a layout of an integrated circuit having a shape with a perimeter;
expanding at least a part of a segment of the perimeter of the shape to generate an expanded segment;
forming a route segment in response to the expanded segment;
generating at least a part of a route with the route segment; and
routing a net in the layout of the integrated circuit using the part of the route.

16. The method of claim 15, wherein the at least the part of the segment of the perimeter includes multiple segments of the shape.

17. The method of claim 15, wherein the at least the part of the segment of the perimeter includes less than all segments of the shape.

18. The method of claim 15, further comprising:
finding coordinates of the expanded at least the part of the segment of the perimeter; and
routing the net using the coordinates.

19. A system, comprising:
a memory configured to store a layout of an integrated circuit having a shape with a perimeter; and
a processor coupled to the memory and configured to:
offset at least a part of a segment of the perimeter of the shape from the perimeter to generate an offset segment;
form a route segment in response to the offset segment;
generate at least a part of a route with the route segment; and
route a net in the layout of the integrated circuit using the part of the route.

20. The system of claim 19, wherein the at least the part of the segment of the perimeter includes a less than all of a segment of the perimeter.

21. The system of claim 19, wherein the at least the part of the segment of the perimeter is an arc.

22. The system of claim 19, wherein the processor is further configured to:
generate a vertex using the at least the part of the segment of the perimeter;
extend a segment from the vertex; and
route the net using the segment extended from the vertex.

23. The system of claim 22, wherein the segment extended from the vertex extends substantially perpendicular to the perimeter.

24. The system of claim 19, wherein the processor is further configured to:
select a plurality of segments of the shape;
offset each of the selected segments of the shape in a direction substantially perpendicular to a corresponding edge of the shape; and
lengthen each of the offset segments of the shape to intersect with at least one other offset segment.

25. The system of claim 19, wherein the shape is an octagon.

26. The system of claim 19, wherein the shape is a bump.

27. The system of claim 19, wherein the shape is a second net.

28. The system of claim 19, the net referred to as a first net, wherein the processor is further configured to:
route a second net from a bump to a pin;
wherein the shape includes at least one of the bump and the second net.

29. The system of claim 19, wherein the processor is further configured to route the first net to a via adjacent the bump.

30. The system of claim 19, wherein the processor is further configured to:
expand a perimeter of a second shape to generate at least one segment of a third shape; and
route the net using the at least one segment of the third shape.

31. The system of claim 19, wherein the processor is further configured to route the net on a redistribution layer of a semiconductor device.

32. A non-transitory computer-readable medium having instructions stored thereon, the instructions comprising instructions for:
receiving a layout of an integrated circuit having a shape with a perimeter;
offsetting at least a part of a segment of the perimeter of the shape from the perimeter to generate an offset segment;
forming a route segment in response to the offset segment;
generating at least a part of a route with the route segment; and
routing a net in the layout of the integrated circuit using the part of the route.

33. The computer-readable medium of claim 32, wherein the at least the part of the segment of the perimeter includes a less than all of a segment of the perimeter.

34. The computer-readable medium of claim 32, wherein the at least the part of the segment of the perimeter is an arc.

35. The computer-readable medium of claim 32, the instructions further comprising instructions for:
generating a vertex using the at least the part of the segment of the perimeter; and
extending a segment from the vertex;
wherein routing the net comprises routing the net using the segment extended from the vertex.

36. The computer-readable medium of claim 35, wherein the segment extended from the vertex extends substantially perpendicular to the perimeter.

37. The computer-readable medium of claim 32, wherein:
offsetting the at least the part of the perimeter of the shape comprises:
selecting a plurality of segments of the shape; and
offsetting each of the selected segments of the shape in a direction substantially perpendicular to a corresponding edge of the shape; and
the instructions further comprise instructions for lengthening each of the segments of the shape to intersect with at least one other segment of the shape to generate the at least the part of the route.

38. The computer-readable medium of claim 32, the net referred to as a first net, the instructions further comprising instructions for:
routing a second net from a bump to a pin;
wherein the shape includes at least one of the bump and the second net.

39. The computer-readable medium of claim 38, the instructions further comprising instructions for routing the first net to a via adjacent the bump.

40. The computer-readable medium of claim 32, the instructions further comprising instructions for:
expanding a perimeter of a second shape to generate at least one segment of a third shape; and
routing the net using the at least one segment of the third shape.
